(19) United States
(12) Patent Application Publication
(10) Pub. No.: US 2025/0277503 A1
(43) Pub. Date: Sep. 4, 2025

(54) PIN FOR MUTUALLY ASSEMBLING TWO PARTS

(71) Applicant: ETA SA Manufacture Horlogère Suisse, Grenchen (CH)

(72) Inventors: Christophe DONZE, Pieterlen (CH); Patric PHAM, Utzenstorf (CH)

(73) Assignee: ETA SA Manufacture Horlogère Suisse, Grenchen (CH)

(21) Appl. No.: 19/045,062

(22) Filed: Feb. 4, 2025

(30) Foreign Application Priority Data
Feb. 29, 2024 (EP) 24160570.8

(51) Int. Cl. F16B 21/08

(52) U.S. Cl. CPC F16B 21/086

(57) ABSTRACT

A pin (10) extending along a longitudinal axis between a first end (100) intended to be rigidly connected to a first part (30) and a second end (200) intended to be engaged in a recess (21) in a second part (20), with a fit without mechanical play, the second end (200) having a cut-out (210) delimiting an unmoving part (220) and a flexible part (230) and passing through, from end to end, the second end (200) transversely to the longitudinal axis, the cut-out (210) being configured so as to have, in a plane P containing the longitudinal axis, a projection whose general shape is asymmetrical.

### CROSS REFERENCE TO RELATED APPLICATIONS

This application is claiming priority based on European Patent Application No. 24160570.8 filed on Feb. 29, 2024.

### TECHNICAL FIELD OF THE INVENTION

The invention relates to the field of mechanics and in particular to elements that allow the relative positioning and mutual assembly of two parts.

More specifically, the invention relates to a pin for mutually assembling two parts.

### TECHNOLOGICAL BACKGROUND

In an assembly of two parts, one or more pins can be used to precisely position the parts to be assembled in relation to each other. In particular, the one or more pins are inserted into recesses extending respectively into the two parts to be assembled.

However, inserting the pin into the recesses in the parts, and optionally removing the pin, can be relatively tricky due to the friction generated. More specifically, the fits between the pin and the parts are typically particularly tight in order to limit mechanical play and guarantee the most accurate possible positioning of the parts relative to one another.

In order to overcome this drawback, the pins can be axially split so as to be radially resilient and facilitate their engagement into and possible withdrawal from the recesses with which they are intended to cooperate.

However, this resilient behaviour is detrimental to the precision of the relative positioning between the parts of the assembly insofar as the pin can be deformed in an undetermined way when the assembly is produced, and thus vary the possible offset of one part in relation to the other, from one assembly to the next.

Moreover, inserting the pin into the recesses in the parts can also cause damage to the pin and/or to the parts due to friction in the case of near-zero clearances, or even clamping depending on the assembly tolerances chosen. Positioning accuracy will thus be inversely proportional to the number of positioning operations carried out.

There is thus a need to find a solution that allows two parts to be positioned as precisely as possible in relation to each other, that facilitates assembly and disassembly of the assembly, and that guarantees a repeatable position over the course of assembly operations and over time.

### SUMMARY OF THE INVENTION

The invention overcomes the aforementioned drawbacks and, to this end, relates to a pin extending along a longitudinal axis between a first end intended to be fastened to a first part and a second end intended to be engaged in a recess in a second part, with a fit without mechanical play. The second end has a cut-out delimiting an unmoving part and a flexible part and passing through, from end to end, the second end transversely to the longitudinal axis, the cut-out being configured so as to have, in a plane P containing the longitudinal axis, a projection whose general shape is asymmetrical.

Thanks to these features, the pin according to the invention can ensure precise positioning of the second part relative to the first part. More specifically, when the second end engages in the recess in the second part, the unmoving part does not deform and the positioning of the second part is controlled. Moreover, thanks to the cut-out, any play is always filled in the same direction, thus avoiding some of the uncertainties in the positioning of the parts in relation to each other.

In particular embodiments, the invention can further include one or more of the following features, which must be considered singly or according to any combination technically possible.

In particular embodiments, the cut-out has a first portion extending from an opening towards a free end of the second end.

As the cut-out does not open out into the second end, it is easier to insert the pin into the second part.

In particular embodiments, the cut-out has a second portion connected to the first portion and extending towards the first end as far as a bottom of the cut-out.

In particular embodiments, the second portion is connected to the first portion by a curved portion.

In particular embodiments, the cut-out is configured so that the first and the second portion define an angle α, the bisector of which is materialised by the longitudinal axis of the pin.

In particular embodiments, the free end of the second end forms a point extending along the longitudinal axis of the pin, said point being interposed between a hooking portion via which it is connected to the unmoving part, and a free portion capable of moving between a rest position and a stressed position.

In particular embodiments, the second end has at least one flat section extending over the unmoving part and over the flexible part.

According to another aspect, the present invention further relates to an assembly of a first part and a second part by means of a pin as previously described, in which the first end of the pin is fastened to the first part, or in which the first end of the pin and the first part are constituted by the same part, and the second end of the pin is engaged in a recess in the second part with a fit without mechanical play, so that the flexible part is forced to deform so as to generate a resilient return force which causes the second end to be clamped to the second part.

In particular embodiments, the second end has a diametrical dimension d1 defined between a peripheral surface of the unmoving part and a peripheral surface of the flexible part when the free portion is in a rest position, said peripheral surfaces defining a dimension d2 when the free portion is in a stressed position. The pin is dimensioned such that the dimension d1 is greater than a dimension d3 of a diameter of the recess in the second part, and such that the dimension d2 is equal to said dimension d3.

### BRIEF DESCRIPTION OF THE FIGURES

Other features and advantages of the invention will become apparent from the following detailed description, which is given by way of example and is by no means limiting, with reference to the accompanying drawings in which:

FIG. 1 shows a perspective view of a pin according to one example embodiment of the present invention and a close-up view of one end of the pin;

FIG. 2 shows a side view of the pin shown in FIG. 1;

FIG. 3 shows a front view of the pin shown in FIG. 1.

It should be noted that the figures are not necessarily drawn to scale for clarity purposes.

### DETAILED DESCRIPTION OF THE INVENTION

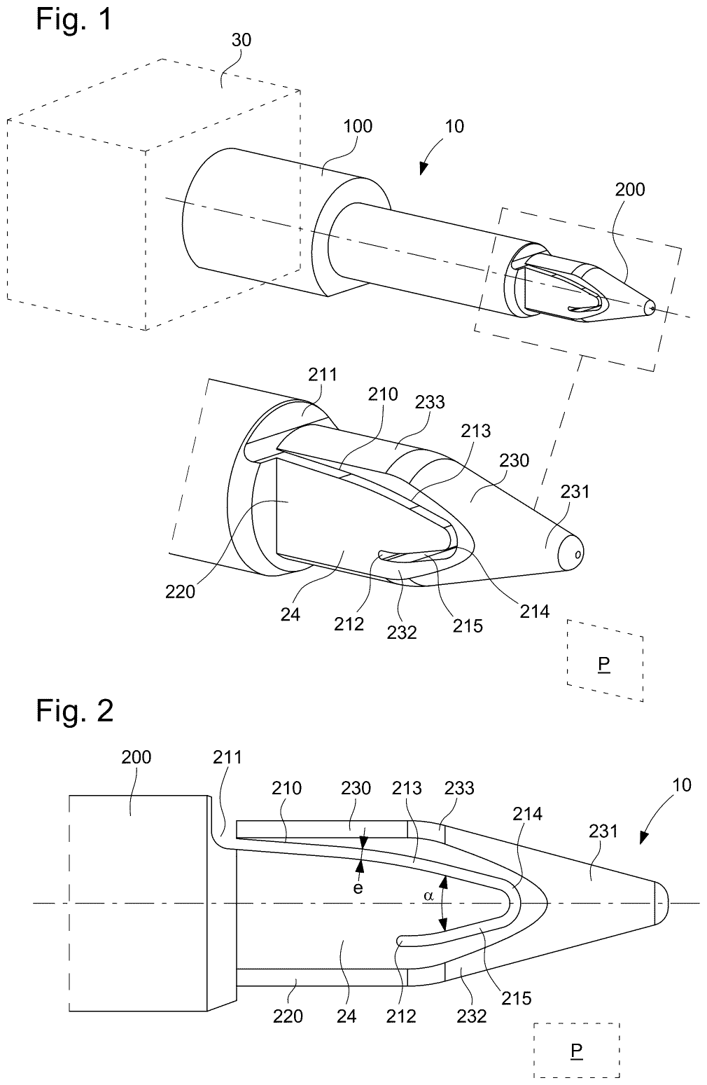

The present invention relates to a pin 10 as shown by way of an example embodiment in FIGS. 1 to 3. The pin 10 is intended to be fastened to a first part 30 and to a second part 20 in order to join them together so as to produce an assembly in which the position of said parts relative to each other is very precise and repeatable.

As can be seen in FIG. 1, the pin 10 extends along a longitudinal axis between a first end 100 intended to be rigidly connected to the first part 30, and a second end 200 intended to be engaged in a recess 21 in the second part 20, with a fit without mechanical play. The pin 10 is preferably made in one piece, i.e. it is made from a single blank of material.

It should be noted that the pin 10 and the first part 30 can be constituted by the same part or by two separate parts. In the latter case, which is preferred, the first end 100 of the pin 10 is intended to be fastened to the first part 30 in the sense that they are intended to be joined together by a mechanical embedded-type connection. The pin 10 can be driven, bonded, or welded, etc., with the first part 30.

In particular, as shown in the close-up view in FIG. 1, the second end 200 has a cut-out 210 separating an unmoving part 220 and a flexible part 230. The unmoving part 220 and the flexible part 230 are respectively non-deformable and resiliently deformable relative to the first end 100 under normal conditions of use of the pin 10, i.e. when the second end 200 is engaged in the second part 20, or optionally disengaged therefrom. The non-deformable and deformable properties of the unmoving part 220 and of the flexible part 230 respectively are conferred by their dimensioning, which as such is within the abilities of a person skilled in the art.

The cut-out 210 is a slot extending lengthwise between an opening 211 and a bottom 212 and passing, from end to end, through the second end 200 transversely to the longitudinal axis, as can be seen in the close-up view in FIG. 1 and FIG. 2. In particular, the cut-out 210 has a projection in a plane P containing the longitudinal axis, the general shape of which is asymmetrical. It should be noted that the expression “asymmetrical general shape” is understood to mean the entire shape of the projection of the cut-out 210. In the example embodiments of the invention shown in the figures, the plane P is orthogonal to a transverse direction in which the cut-out 210 extends.

The shape of the cut-out 210 advantageously distributes the stresses to which the flexible part 230 is subjected when the second part 20 is attached to the pin 10 and increases the pre-stressing of the flexible part 230. Such an arrangement reduces the risk of damage to the pin and helps to ensure that the second part 20 is held in position in the assembly, insofar as it promotes the resilient return of the flexible part 230, as described in more detail below. Moreover, the unmoving part is sufficiently rigid not to deform during the assembly of the first and second part 30 and 20, thus ensuring a very precise and repeatable relative positioning thereof.

As shown in FIG. 2, in a preferred example embodiment of the invention, the cut-out 210 has a first portion 213 extending from the opening 211 towards a free end of the second end 200. The first portion 213 is preferably connected, by a curved portion 214, to a second portion 215 extending as far as the bottom 212 of the cut-out 210. The second portion 215 advantageously extends towards the first end 100, as can be seen in FIGS. 1 and 2, so as to promote the distribution of stresses in the flexible part 230 during the deformation thereof.

In the example embodiment shown in FIG. 2, the cut-out 210 is shaped so that the first and the second portion 213 and 215 define an angle α, the bisector of which is materialised by the longitudinal axis of the pin 10, in order to further contribute to the distribution of stresses in the flexible part 230 during the deformation thereof. For example, the angle α can be between 10 and 50 degrees, or even between 15 and 25 degrees.

In order to facilitate engagement of the second end 200 in the recess 21 in the second part 20, the flexible part 230, and in particular the free end of the second end 200, forms a point 231 extending along the longitudinal axis of the pin 10. The flexible part 230 comprises a hooking portion 232 connecting the point 231 to the unmoving part 220 and a free portion 233 extending towards the first end 100. As can be seen from the figures, the point 231 is thus interposed between the hooking portion 232 and the free portion 233. The pointed shape of the second end 200 makes it easier to engage said end in the recess 21 in the second part 20, while avoiding any risk of damaging the pin and/or the part.

The free portion 233 is configured to be movable between a rest position which it occupies when the second end 200 is not engaged in the recess 21 in the second part 20, as seen in FIGS. 1 to 3, and a stressed position which it occupies when the second end 200 is engaged in the recess 21 in the second part 20. When the free portion 233 occupies the stressed position, it is closer to the unmoving part 220 than it is when it occupies the rest position. In other words, when the second end 200 of the pin 10 is engaged in the recess 21 in the second part 20, the flexible part 230 is forced to deform and generate a resilient return force which causes the clamping forces applied by the second end 200 to the second part 20.

The cut-out 210 can be produced by spark erosion, mechanical machining, laser machining or any other suitable material removal method. Preferably, over at least part of its length, the cut-out 210 has a constant width e when the free portion 233 is in a rest position, as can be seen in the side views of FIG. 2.

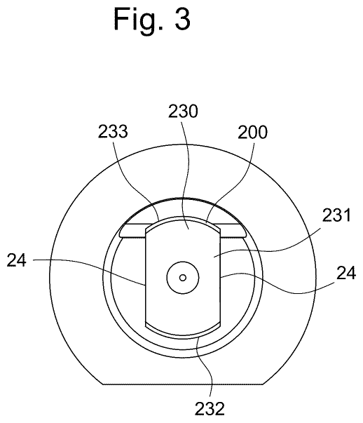

In order to reduce friction with the second part 20 during engagement of the pin 10, and any disengagement, the second end 200 can have at least one flat section 24 extending, preferably in a plane parallel to the longitudinal axis, over the unmoving part 220 and over the flexible part 230. In the example embodiment shown in the figures, the pin 10 comprises two flat sections 24 diametrically opposite and parallel to each other, as shown in FIG. 3. In other example embodiments not shown, the pin 10 can comprise three or more flat sections 24 evenly distributed around the longitudinal axis.

It should be noted that the same assembly can comprise a plurality of pins 10 in order, for example, to eliminate any degree of rotational freedom between the two assembled parts. In particular, one pin 10 can have the function of centring the parts relative to each other, and the other pin 10 can have the function of aligning them relative to each other.

Typically speaking, it follows from the description of the invention given above and from the figures that the second end 200 has a diametrical dimension d1 defined between a peripheral surface of the unmoving part 220 and a peripheral surface of the flexible part 230 when the free portion 233 is in a rest position, said peripheral surfaces defining a maximum dimension d2 when the free portion 233 is in a stressed position. The pin 10 is dimensioned such that the dimension d1 is greater than a dimension d3 of a diameter of the recess 21 in the second part 20, and such that the dimension d2 is equal to said dimension d3.

More generally, it should be noted that the implementations and embodiments considered above have been described by way of non-limiting examples, and that other alternatives are thus possible.

1. A pin (10) extending along a longitudinal axis between a first end (100) intended to be rigidly connected to a first part (30) and a second end (200) intended to be engaged in a recess (21) in a second part (20), with a fit without mechanical play,
wherein the second end (200) has a cut-out (210) delimiting an unmoving part (220) and a flexible part (230) and passing through, from end to end, the second end (200) transversely to the longitudinal axis, the cut-out (210) being configured so as to have, in a plane P containing the longitudinal axis, a projection whose general shape is asymmetrical, the cut-out (210) having a first portion (213) extending from an opening (211) towards a free end of the second end (200) and a second portion (215) connected to the first portion (213) and extending towards the first end (100) as far as a bottom (212) of the cut-out (210).

2. The pin (10) according to claim 1, wherein the second portion (215) is connected to the first portion (213) by a curved portion (214).

3. The pin (10) according to claim 1, wherein the cut-out (210) is configured so that the first and the second portion (213, 215) define an angle α, the bisector of which is materialised by the longitudinal axis of the pin (10).

4. The pin (10) according to claim 1, wherein the free end of the second end (200) forms a point (231) extending along the longitudinal axis of the pin (10), said point (231) being interposed between a hooking portion (232) via which it is connected to the unmoving part (220), and a free portion (233) capable of moving between a rest position and a stressed position.

5. The pin (10) according to claim 1, wherein the second end (200) has at least one flat section (24) extending over the unmoving part (220) and over the flexible part (230).

6. An assembly of a first and of a second part (20) by way of the pin (10) according to claim 1, wherein the first end (100) of the pin (10) is fastened to the first part (30) and the second end (200) of the pin (10) is engaged in a recess (21) in the second part (20), with a fit without mechanical play, such that the flexible part (230) is forced to deform and generate a resilient return force which causes the clamping forces applied by the second end (200) to the second part (20).

7. The assembly of a first and of a second part (20) by way of a pin (10) according to claim 1, wherein the first end (100) of the pin (10) and the first part (30) are constituted by the same part, the second end (200) of the pin (10) being engaged in a recess (21) in the second part (20), with a fit without mechanical play, such that the flexible part (230) is forced to deform and generate a resilient return force which causes the clamping forces applied by the second end (200) to the second part (20).

8. The assembly according to claim 6, wherein the second end (200) has a diametrical dimension d1 defined between a peripheral surface of the unmoving part (220) and a peripheral surface of the flexible part (230) when the free portion (233) is in a rest position, said peripheral surfaces defining a dimension d2 when the free portion (233) is in a stressed position, the pin (10) being dimensioned such that the dimension d1 is greater than a dimension d3 of a diameter of the recess (21) in the second part (20), and such that the dimension d2 is equal to said dimension d3.
